(19) United States
(12) Patent Application Publication
(10) Pub. No.: US 2015/0091508 A1
(43) Pub. Date: Apr. 2, 2015

(54) BI-DIRECTIONAL COMMUNICATION WITH A DEVICE UNDER CHARGE

(71) Applicant: BLACKBERRY LIMITED, Waterloo (CA)

(72) Inventors: Marc Élis Meunier, Kitchener (CA); Vahid Moosavi, Kitchener (CA); Scott Douglas Rose, Waterloo (CA); Lyall Kenneth Winger, Waterloo (CA); Ahmed Abdelsamie, Nepean (CA); Gerald Robert Dwyer, Brookline, MA (US)

(73) Assignee: BLACKBERRY LIMITED, Waterloo (CA)

(21) Appl. No.: 14/211,436

(22) Filed: Mar. 14, 2014

Related U.S. Application Data
(63) Continuation-in-part of application No. 14/042,914, filed on Oct. 1, 2013.

(51) Int. Cl. B60L 11/18

(52) U.S. Cl. CPC B60L 11/1838; B60L 11/182
USPC 320/108; 320/137

(57) ABSTRACT

A charger that is part of a system including an electronic appliance wirelessly charges a first device. During the wireless charging, the charger sends, to the first device, a first message. In response to the first message, the electronic appliance receives a second message requesting a specified action by the electronic appliance.

### CROSS-REFERENCE TO RELATED APPLICATION

This application is a continuation-in-part of U.S. application Ser. No. 14/042,914 filed Oct. 1, 2013, the disclosure of which is hereby incorporated by reference.

### BACKGROUND

Wireless power allows an electronic device to be provided with power without the use of wires. A power transmitter transfers energy in a wireless manner to a power receiver. Inductive coupling can be used to transfer electromagnetic energy between the power transmitter and the power receiver. The energy that is transmitted to the power receiver can be used by the power receiver to charge a battery of the power receiver, and to provide power to components of the power receiver to allow the components to operate.

### BRIEF DESCRIPTION OF THE DRAWINGS

Some embodiments are described with respect to the following figures.

FIG. 1 is a block diagram of an example arrangement that includes a power charger and a device under charge (DUC), in accordance with some implementations.

FIG. 2 is a schematic diagram of content of a Near-Field Communication (NFC) Data Exchange Format (NDEF) message, according to some examples.

FIG. 3 is a block diagram of further components in a power charger and a DUC, according to further implementations.

FIG. 4 is a flow diagram of a process relating to bi-directional communication between a power charger and a DUC, according to some implementations.

FIGS. 5 and 6 are block diagrams of further example arrangements including a power charger and a DUC, according to further implementations.

FIG. 7 is a block diagram of an example arrangement including a system and a DCU, according to alternative implementations.

FIG. 8 is a flow diagram of a messaging process according to alternative implementations.

### DETAILED DESCRIPTION

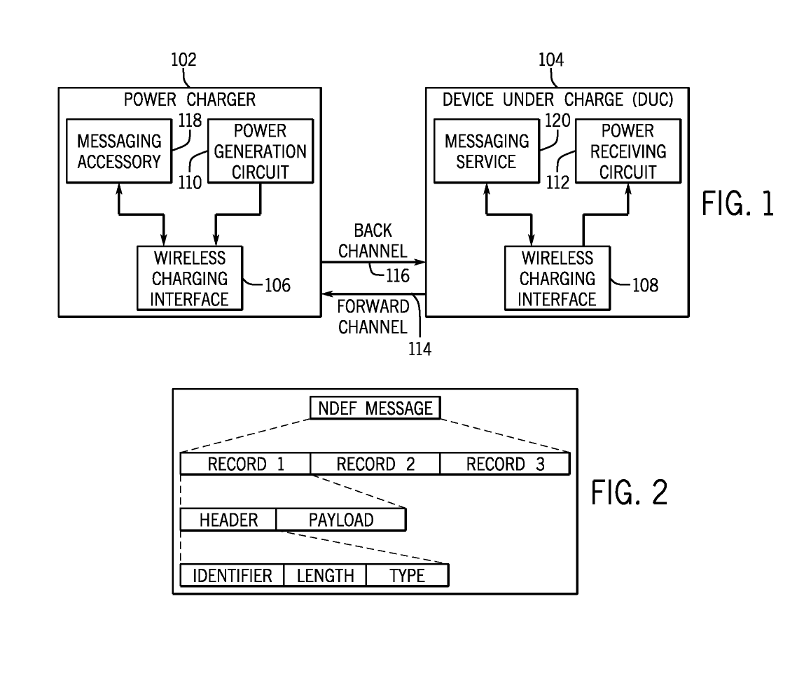

FIG. 1 is a block diagram of an example arrangement that includes a power charger 102 (also referred to as a power transmitter) and a device under charge (DUC) 104 (also referred to as a power receiver). Examples of DUCs can include any or some combination of the following: a smartphone, a portable digital assistant, a tablet computer, a notebook computer, a game appliance, or any other portable device or other type of electronic device that can be wirelessly charged.

The power charger 102 can be any device that includes or is coupled to a power source, such as an AC wall outlet, a battery, and so forth. The power charger 102 can be a charging station or a docking station. In some examples, the power charger 102 can include a flat upper surface on which one or more DUCs can be placed for wireless charging. In other examples, the power charger 102 is able to wirelessly charge one or more DUCs within a specified distance of the power charger 102.

A power charger wirelessly charging a DUC refers to the power charger producing electrical energy (e.g. electromagnetic energy) that can be received by the DUC in a wireless manner, where the received electrical energy can be used to charge a battery of the DUC, or power component(s) of the DUC, or both.

The power charger 102 includes a wireless charging interface 106, and the DUC 104 includes a wireless charging interface 108. The wireless charging interfaces 106 and 108 allow the power charger 102 to wirelessly charge the DUC 104. For example, the wireless charging can be accomplished by using inductive coupling, in which electromagnetic energy is transferred from the power charger 102 to the DUC 104.

Inductive coupling is performed between induction coils, including a first induction coil in the wireless charging interface 106 and a second induction coil in the wireless charging interface 108. When the power charger 102 and the DUC 104 are brought into sufficient proximity with each other (to within a specified distance of each other), an electromagnetic field produced by the first induction (in the wireless charging interface 106 of the power charger 102) induces an electrical current in the second induction coil in the wireless charging interface 108 of the DUC 104.

To allow for wireless charging at greater distances between the power charger 102 and the DUC 104, some implementations can employ resonant inductive coupling, in which finely tuned resonant circuits are used in the wireless charging interfaces 106 and 108. Resonant inductive coupling transfers power between two inductive coils that are tuned to the same resonant frequency.

In some implementations, the power charger 102 and the DUC 104 can perform wireless charging according to a wireless charging protocols provided by the Wireless Power Consortium (WPC). An example of a wireless charging protocol is described by the Qi standard from the WPC. In other examples, other wireless charging protocols can be employed, such as protocols provided by the Power Matters Alliance (PMA) or other organizations.

Although reference is made to WPC wireless charging according to some implementations, it is noted that in other implementations, wireless charging of the DUC 104 by the power charger 102 can be according to other techniques.

In addition to the first induction coil, the wireless charging interface 106 of the power charger 102 can further include a wireless charging integrated circuit (IC) device. Similarly, the wireless charging interface 108 can include a wireless charging IC device in addition to the second inductive coil. Each wireless charging IC device can control various operations associated with wireless charging.

The power charger 102 also includes a power generation circuit 110, which produces power that is provided to the wireless charging interface 106 for transfer to the DUC 104. The power generation circuit 110 can produce power from an external power source (e.g. external wall outlet or external battery) or from an internal power source (e.g. internal battery), as examples.

The DUC 104 includes a power receiving circuit 112, which is able to receive power obtained by the wireless charging interface 108 from the power charger 102. The power receiving circuit 112 can include a battery to be charged by the wireless power, and/or circuitry for delivering power to components of the DUC 104.

The WPC Qi standard specifies forward channel communication (over a forward channel 114) from the DUC 104 to the power charger 102. The forward channel communication is over a wireless link established between the wireless charging interfaces 106 and 108. However, the current WPC Qi protocol does not specify communication in the reverse direction, from the power charger 102 to the DUC 104.

The forward channel 114 can be used by the DUC 104 to communicate various messages relating to wireless charging. For example, the DUC 104 can send packets over the forward channel 114 that identify the DUC 104 and that provide configuration and setup information to the power charger 102 for allowing the power charger 102 to wirelessly charge the DUC 104. In addition, the DUC 104 can send control error packets over the forward channel 114 to the power charger 102, where the control error packets are used to increase or decrease the supply of power from the power charger 102 to the DUC 104.

The unidirectional nature of communications between the power charger 102 and the DUC 104 constrains the flexibility of the features that can be provided by the power charger 102 to the DUC 104. In other words, the power charger 102 would be able to provide just wireless charging services to the DUC 104 by using the unidirectional communications provided by the current WPC Qi standard.

In accordance with some implementations, to enhance features that can be provided by the power charger 102 to DUCs, back channel communications can be provided from the power charger 102 to a DUC. As depicted in FIG. 1, a back channel 116 is provided from the power charger 102 to the DUC 104, where the back channel 116 is provided over a wireless link provided by the wireless charging interfaces 106 and 108.

It is noted that the wireless link that provides for the back channel 116 is a wireless link established between the wireless charging interfaces 106 and 108. This avoids having to provide additional communication interfaces in the power charger 102 and the DUC 104 to allow for the establishment of bi-directional communications between the power charger 102 and the DUC 104.

An example of a wireless communication between devices includes near field communication (NFC), which is provided by NFC standards defined by the NFC Forum. To allow for NFC communications, devices can include antennas that create electromagnetic fields when activated. Through magnetic induction, devices can perform NFC communications with each other over short distances, typically less than four centimeters, for example.

However, if NFC communications using traditional NFC interface circuits were to be employed while the power charger 102 is charging the DUC 104, the electromagnetic field created by the wireless charging interface 106 into the power charger 102 may saturate the NFC antennas, and may render such NFC antennas inoperable.

Although reference is made to NFC communications being affected by wireless charging between the power charger 102 and DUC 104, it is noted that other types of wireless communications may also similarly be affected by the wireless charging.

To address the forgoing issue, instead of using separate short-range interface circuits for performing bi-directional communication between the power charger 102 and the DUC 104 when the DUC 104 is brought into close proximity to the power charger 102, the wireless charging interfaces 106 and 108 themselves can be used for the purpose of establishing bi-directional communications over the forward channel 114 and the back channel 116.

As depicted in FIG. 1, a messaging accessory 118 is provided in the power charger 102 to generate messages that are carried over the back channel 116 to the DUC 104. The messaging produced by the messaging accessory 118 includes information other than information relating to wireless charging. Information relating to wireless charging includes information that is used by either or both of the power charger 102 and DUC 104 for purposes of performing control of the wireless charging. Such information can include status information relating to the wireless charging, authentication information authenticating the power charger 102 and/or the DUC 104 for the purpose of authorizing the wireless charging, and any other information related to performing wireless charging.

Examples of messaging that carries information other than information relating to wireless charging includes any one or more of the following: NFC messaging, identification information, status and control information that is other than information relating to wireless charging, and generic messaging for carrying information relating to a sensor or an application in the power charger 102 or an external entity coupled to the power charger 102.

NFC messaging includes an NFC message formatted according to a specific format, such as the NFC Data Exchange Format (NDEF), such as described in the NDEF Technical Specification provided by the NFC Forum. An example of an NDEF message is depicted in FIG. 2. An NDEF message can be used to encapsulate various types and lengths of payload. An NDEF message can contain multiple records that describe unique payloads. Each record includes a header and a payload, where the header indicates the type of message. As further shown in FIG. 2, the header includes an identifier field, a length field, and a type field.

Identification information that can be communicated over the back channel 116 can include a Universal Serial Bus (USB) identifier (ID) that provides an identification of an accessory associated with the power charger 102, a serial number of the power charger 102, an identifier to indicate a class or type of the power charger 102 (such as whether the power charger 102 has a display, a keyboard, a keypad, or other accessory device), or other identification information that is usable by the DUC 104 to determine features available at the power charger 102. For example, the power charger 102 can be considered a “smart” charging or docking station that has features in addition to features relating to wireless charging. The identification information provided over the back channel 114 can allow the DUC 104 to determine what these additional features are.

Note that, in some examples, the DUC 104 can also send identification information (or other information) to the power charger 102 to allow the power charger 102 to identify features of the DUC 104.

More generally, the messaging accessory 118 can provide messaging produced internally in the power charger 102, such as by application software executing in the power charger 102. Alternatively, the messaging accessory 118 can receive messaging from an external entity that is coupled to the power charger 102 over a network (wired or wireless network). For example, the external entity can be a website or any other source of information. The messaging accessory 118 can also allow the DUC 104 to establish a communications session (e.g. web browsing session, call session, chat session, etc.) with the external entity.

In further examples, the power charger 102 can emulate the behavior of an NFC tag. The NFC tag of the power charger 102 can perform one or more of the following functions. For example, the NFC tag and the power charger 102 can enable the establishment of a Bluetooth or a Wi-Fi communications session between the DUC 104 and the power charger 102, using the bi-directional communications provided over the forward channel 114 and the back channel 116.

As another example, the NFC tag can provide the functionality of an NFC smart poster, which is an example of a tag reading function. In this example, the NFC tag stores information that is read by the DUC 104 (over the back channel 116), where the information can include a Uniform Resource Identifier (URI) that the DUC 104 can use for various purposes, such as to open a web page at a remote website, call a number, send an email, send a text message, and so forth. Additionally, the NFC smart poster can include certain information that may be of interest to the user of the DUC 104. For example, such information in the NFC Smart Poster can include a timetable for a bus stop, an airline schedule, and so forth.

Another NFC tag reading function includes provision of a coupon by the power charger 102 to the DUC 104 over the back channel 116, where the coupon can offer a rebate on a good or service that can be purchased by a user of the DUC 104. As another example, an NFC tag reading function can include accessory detection, where the DUC 104 can detect a class or type of an accessory associated with the power charger 102, such that the DUC 104 can set itself up in the corresponding mode to perform communication or interact with the accessory associated with the power charger 102.

NFC tag writing can also be performed. With NFC tag writing, the DUC 104 can provide a message over the forward channel 114 to leave at the NFC tag of the power charger 102. Also, the power charger 102 can provide responsive information pertaining to the tag writing back to the DUC 104 over the back channel 116.

As another example, peer-to-peer communications can be performed between the power charger 102 and the DUC 104 using the forward channel 114 and back channel 116. For example, handshaking associated with setup of a Bluetooth, Wi-Fi, or other communication session can be exchanged in peer-to-peer communications. As a further example, the peer-to-peer communications can be performed for automatic credential setup when the DUC 104 visits a website.

Peer-to-peer communications allows the power charger 102 and DUC 104 to easily share information when they are brought into close proximity with each other. For example, information that can be shared includes photos, videos, music, and other data.

Card emulation can also be performed by the power charger 102. For example, the power charger 102 can include a secure storage device (e.g. a passive tag or other storage device) that can store credit card information or other financial information that can be used to pay for a good or service.

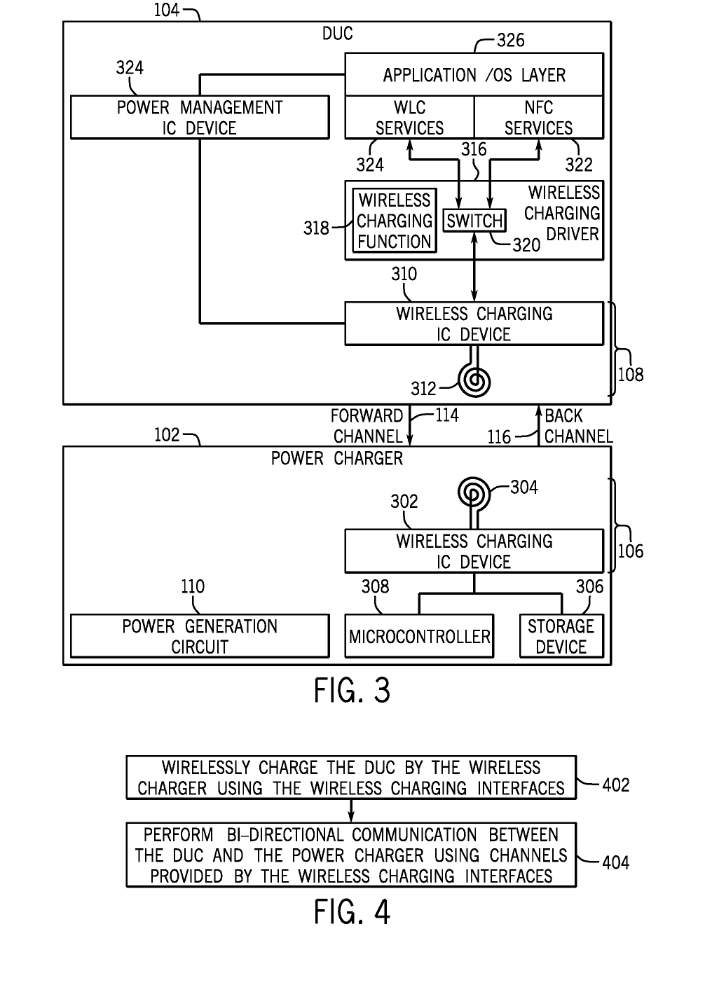

FIG. 3 is a block diagram of illustrating further components of the power charger 102 and DUC 104 according to further implementations. The power charger 102 includes a wireless charging IC device 302 and an induction coil 304, which are part of the wireless charging interface 106 in FIG. 1. In addition, the power charger 102 includes a storage device 306 and a microcontroller 308. The storage device 306 can include a flash memory device, an electrically erasable and programmable read-only memory (EEPROM), or an embedded secure element that is embedded in another device. The storage device 306 can be used to store information that can be provided in messaging communicated over the back channel 116 from the power charger 102 to the DUC 104. In some examples, at least a portion of the storage device 306 is a secure storage element that prevents unauthorized access of data contained in the secure storage element.

The messaging accessory 118 depicted in FIG. 1 can include the microcontroller 308 or the storage device 306, or both. For example, machine-readable instructions (e.g. firmware or software instructions) can be executable by the microcontroller 308 to perform various operations, including producing messages or receiving messages that are to be sent to the DUC 104 over the back channel 116. In alternative examples, instead of the microcontroller 308, a microprocessor or other programmable device can be included in the power charger 308, to provide certain functionalities of the messaging accessory 118.

The DUC 104 includes a wireless charging IC device 310 and an induction coil 312, which can be part of the wireless charging interface 108 of FIG. 1. The DUC 104 also includes a power management IC device 314, which can be part of the power receiving circuit 112 of FIG. 1.

In addition, the DUC 104 includes a wireless charging driver 316, which can be implemented as machine-readable instructions executable on one or more processors (not shown in FIG. 3) of the DUC 104. The wireless charging driver 316 includes a wireless charging function 318, which provides functions associated with wireless charging of the DUC 104 by the power charger 102. For example, the wireless charging function 318 can provide various information (as discussed above) over the forward channel 114 to the power charger 102, which uses this information to control perform wireless charging of the DUC 104.

The wireless charging driver 316 also includes a switch 320, which can direct received messages to one of multiple services modules 322 and 324, in some implementations. The services module 322 is an NFC services module, which is able to send and receive NFC-related messages, such as NDEF messages. NDEF messages received by the switch 320 from the wireless charging IC device 310 are routed by the switch 320 to the NFC services module 322.

In some cases, to reduce the amount of information communicated over the back channel 116, NDEF header information of NDEF messages may be removed such that just the payloads of the NDEF messages are sent over the back channel 116. The receiver (e.g. wireless charging IC device 310 or wireless charging driver 316) in the DUC 104 can re-construct the NDEF header information upon receipt of an NDEF payload, to re-formulate the respective NDEF message. The power charger 102 can provide an indication to the DUC 104 that an NDEF payload has been sent; as a result, the DUC 104 is able to re-formulate the NDEF message upon receipt of the NDEF payload.

Non-NDEF messages received by the switch 320 are routed by the switch 320 to a wireless charging (WLC) services module 324. As examples, non-NDEF messages can include identification information (e.g. USB ID, serial number, etc.) or other type of information that relates to an identification or features of the power charger 102.

In other examples, instead of providing multiple services modules 322 and 324, one of the services module 322 and 324 can be omitted. As further examples, more than two services modules can be included in the DUC 104.

The services modules 322 and 324 can be implemented as machine-readable instructions that are provided between the wireless charger driver 316 and an application and operating system layer 326. In other examples, the services module 322 and/or 324 can be provided in the wireless charging driver 316. The application and operating system layer 326 can include application software and an operating system of the DUC 104.

FIG. 4 is a flow diagram of a process according to some implementations. The process includes wirelessly charging (at 402) the DUC 104 by the power charger 102 using the wireless charging interfaces (108 and 106, respectively) of the DUC 104 and the power charger 102. In addition, the process includes performing (at 404) bi-directional communication between the DUC 104 and the power charger 102 over the forward channel 114 and back channel 116 established between the wireless charging interfaces 108 and 106, while the power charger 102 is wirelessly charging the DUC 104. The bi-directional communication includes messaging from the power charger 102 to the DUC 104 over the back channel 116, where the messaging includes information other than (and in addition to) information relating to wireless charging.

In some examples, an I2C relay can be used to perform communications between the power charger 102 and the DUC 104. I2C communication is performed over an I2C bus between an I2C master and an I2C slave. I2C communication can be according to the I2C bus specification. An I2C relay is a bridge that allows one I2C device on a first I2C bus to access another I2C device located on a different I2C bus; the I2C relay does not have to interpret the data carried between the I2C devices.

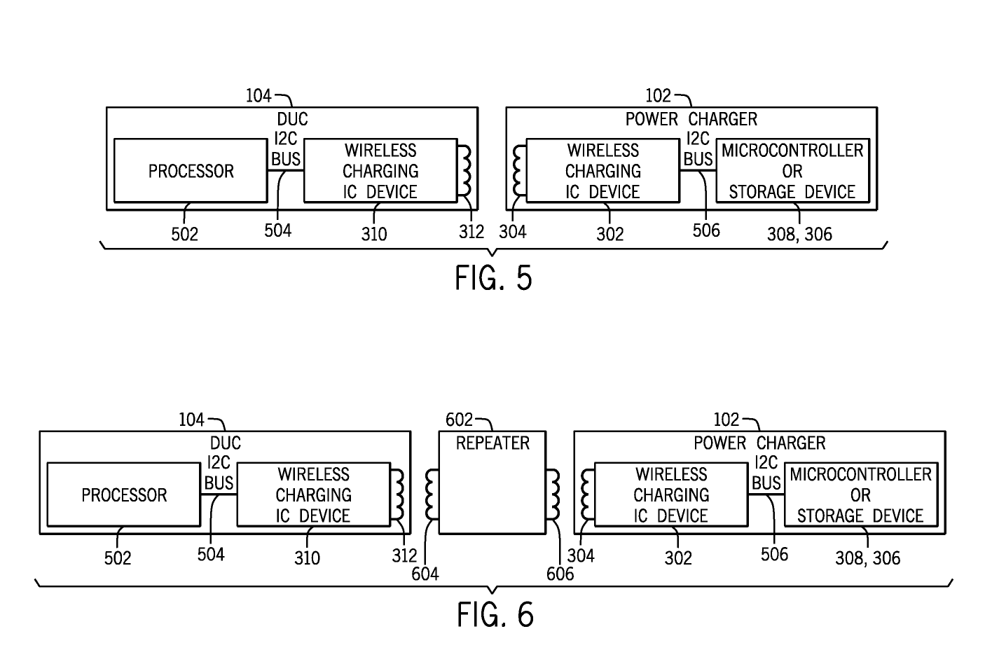

As shown in FIG. 5, the DUC 104 includes a processor 502 and the wireless charging IC device 310. The processor 502 can be the processor on which various machine-readable instructions of the DUC 104, including the wireless charging driver 316, services modules 322 and 324, and the application and OS layer 326, are executable. A processor can include a microprocessor, microcontroller, processor module or subsystem, programmable integrated circuit, programmable gate array, or another control or computing device.

The processor 502 behaves as an I2C master on an I2C bus 504, while the wireless charging IC device 310 behaves as an I2C slave on the I2C bus 504.

In the power charger 102, the wireless charging IC device 302 is an I2C master on an I2C bus 506, while the microcontroller 308 or storage device 306 is an I2C slave on the I2C bus 506.

Although reference is made to use of an I2C bus in some examples, it is noted that, in other examples, other types of communication buses can be used.

In communications from the DUC 104 to the power charger 102 over the forward channel 114, the wireless charging IC device 310 behaves as an I2C slave that transmits an I2C message to the wireless charging IC device 302 (which behaves as an I2C master). The transmission of this I2C message leverages a physical communication layer already provided by the wireless charging interfaces of the DUC 104 and power charger 102. The I2C message is then relayed by the wireless charging IC device 302 to the storage device 306 or microcontroller 308 over the I2C bus 506.

In the reverse direction, from the power charger 102 to the DUC 104 over the back channel 116, the storage device 306 or microcontroller 308 sends an I2C message over the I2C bus 506 to the wireless charging IC device 302. In turn, the wireless charging IC device 302 send the I2C message to the wireless charging IC device 310, which in turn sends the I2C message to the processor 502.

In this arrangement, the wireless charging IC devices 302 and 310 together provide an I2C relay. The I2C relay provides a virtual I2C bus that connects the processor 502 in the DUC 104 with the storage device 306 or microcontroller 308 in the power charger 102.

FIG. 6 illustrates an example of an alternative arrangement in which a wireless charging repeater 602 is provided between the power charger 102 and DUC 104. The repeater 602 is able to forward data between the power charger 102 and DUC 104 without interpreting the content of the data. As shown in FIG. 6, the repeater 602 includes induction coils 604 and 606 to inductively couple to the DUC 104 and power charger 102, respectively, for the purpose of communicating both power and data (over the forward channel 114 and back channel 116).

By leveraging channels (114 and 116) provided by wireless charging interfaces (106, 108) used for wireless charging, bi-directional communications can be performed between the power charger 102 and the DUC 104 while the DUC 104 is being wirelessly charged by the power charger 102. Effectively, the same physical interface is used for both wireless charging and bi-directional communications.

A trigger for bi-directional communication can be based on an exchange of information indicating which of the power charger 102 and DUC 104 wants to establish the bi-directional communication. Assuming that NFC communication is used, once a bi-directional communication (e.g. peer-to-peer communication) is established, the NFC infrastructure (e.g. NFC services module 322 in FIG. 3) of the DUC 104 can be employed, which can simplify the design of the power charger 102 and DUC 104.

In scenarios where the DUC 104 is placed in the proximity of the power charger 102 for an extended duration (for charging the DUC 104), the relatively slow speed of the back channel 116 in some examples may not present an issue.

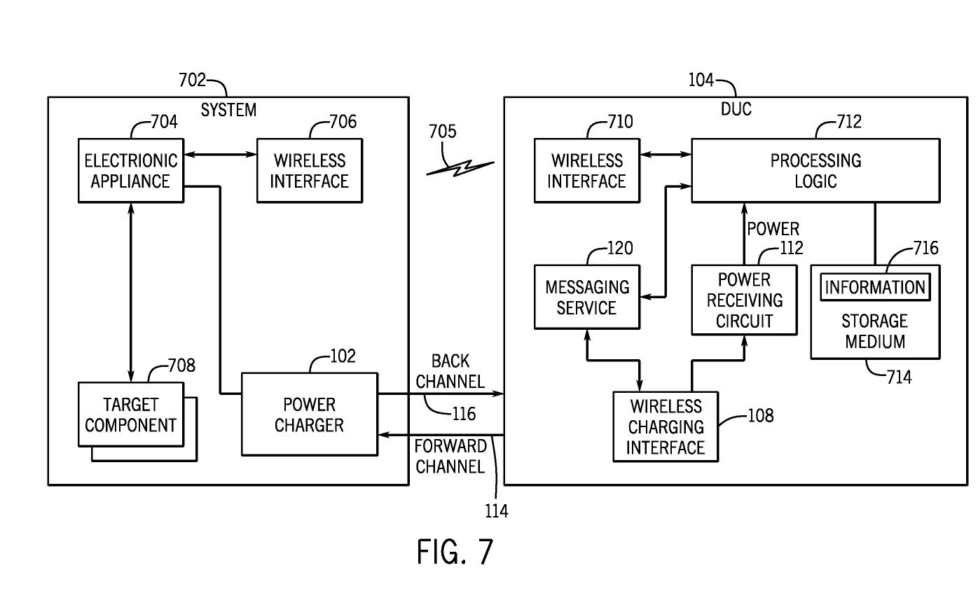

As shown in FIG. 7, the power charger 102 can be part of a larger system 702. The system 702 can be a vehicle, such as a car, boat, airplane, motor cycle, scooter, and so forth. Alternatively, the system 702 can be at another location, such as a public transit location (e.g. an airport, a bus station, a seaport, etc.), a retail location (e.g. coffee shop, restaurant, retail store, etc.), a school campus, a government office, and so forth.

The system 702 includes an electronic appliance 704. The electronic appliance 704 can refer to any electronic subsystem that is capable of communicating messaging with the DUC 104, either through the power charger 102 or over a wireless link 705 (e.g. Wi-Fi link, Bluetooth link, etc.) established between a wireless interface 706 of the system 702 and a wireless interface 710 of the DUC 104. Alternatively, the electronic appliance 704 can communicate with the DUC 104 through the power charger 102 and the forward and back channels 114 and 116.

The electronic appliance 704 can further include a control subsystem that can perform various control tasks, such as setting up the wireless link 705 between the system 702 and the DUC 104, and controlling or otherwise interacting with one or more target components 708 in the system 702. A target component 708 can be an adjustable component, such as an adjustable seat in a vehicle, an entertainment system (e.g. audio system, video system, or both) in a vehicle, a navigation system in a vehicle, an air-conditioning system (e.g. a cooling system, a heater system, or both) in a vehicle, an adjustable mirror in a vehicle, an adjustable steering wheel in a vehicle, a phone communication system in a vehicle, and so forth.

In other example contexts, a target component 708 can include an entertainment system at a different location (e.g. airport lounge or other location, where a user can see a movie or listen to music, for example), a public transit update subsystem (e.g. a subsystem that can deliver flight status or other updates to the DUC 104), and so forth.

Alternatively, a target component 708 can be a toll tag that can be read by a toll station. In some examples, the toll tag can be attached to a vehicle. When the vehicle passes through a toll station, the toll station can read the toll tag for the purpose of charging a user of the vehicle.

In more specific examples, if the target component 708 is an adjustable component in a vehicle (e.g. adjustable seat, adjustable mirror, adjustable steering wheel, etc.), the adjustable component can be adjusted to a favorite position for each respective user (e.g. driver or passenger). As an example, an identifier of the user, or information pertaining to a setting of the user, can be stored in the DUC 104. When the user carrying the DUC 104 enters the vehicle and the DUC 104 is able to communicate with the system 702, this identifier or setting can be communicated to the electronic appliance 708, which can then use the identifier or setting to adjust the position of the adjustable component.

As another example, if the target component 708 is an entertainment system, then the DUC 104 can store various information pertaining to favorite stations (e.g. radio stations, TV channels, movie channels, etc.) of a user of the DUC 104. Such information regarding favorite stations can be communicated from the DUC 104 to the electronic appliance 704 for the purpose of setting up the entertainment system with the favorite stations. Additionally, the DUC 104 can store configuration information that can be used for configuring the entertainment system or an accessory of the entertainment system. For example, the configuration information can be communicated to the electronic appliance 704 for configuring a headset (e.g. Bluetooth headset) for a user, configuring a brightness or other display settings of a display of the entertainment system, and so forth.

As a further example, if the target component 708 includes an air-conditioning in a vehicle, then the temperature of the air-conditioning system can be automatically adjusted based on an identifier or setting stored in the DUC 104 which is communicated to the electronic appliance 704.

As a further example, if the target component 708 includes a navigation system in a vehicle, then favorite geographic locations stored in the DUC 104 can be communicated to the electronic appliance 704, which can present such favorite geographic locations for display by the navigation system so that a user of the vehicle can select one of the favorite navigation locations for navigation routing purposes.

As a further example, if the target component 708 includes a phone communication system in a vehicle, then contacts stored in the DUC 104 can be communicated to the electronic appliance 704. The contacts can be displayed by a display of the phone communication system of the vehicle for selection by a user to make a phone call.

As a further example, if the target component 708 includes a toll tag attached to a vehicle, then information relating to a user account to which a toll can be charged can be sent from the DUC 104 to the electronic appliance 704. This account information can then be written to the toll tag, and the account information can be read by a toll station when the vehicle passes through a toll station. Payment of the toll is charged to the account. The toll tag can be programmed with different account information for different users, depending on which user is driving or riding in the vehicle.

As another example, the electronic appliance 704 or the power charger 102 can send wireless link messaging to the DUC 104, where the wireless link messaging can contain information relating to setting up the wireless link 705 between the system 702 and the DUC 104. In some implementations, the information can include an identifier of a wireless network (such as a service set identifier or SSID), a credential such as a password or passcode, and so forth. The credential can be a credential for setting up a Wi-Fi link or a Bluetooth link, for example.

The DUC 104 includes processing logic 712 to perform various tasks. The processing logic 712 can include one or multiple processors. In some implementations, the processing logic 712 can include machine-readable instructions (e.g. an application) that are executable on the processor(s). In other implementations, the processing logic 712 can be a hardware component, such as an application-specific integrated circuit (ASIC), a microcontroller, and so forth.

The processing logic 712 is able to communicate either with the messaging service 120 (to perform communications over the forward and back channels 114 and 116) of the DUC 104, or with the wireless interface 710 (to perform communications over the wireless link 105), or both. The processing logic 712 is able to communicate with the electronic appliance 704 to perform any of the tasks discussed above.

The DUC 104 further includes a storage medium 714 to store information 716, which can include any of the various information discussed above (e.g. an identifier of a user, a setting relating to an adjustable component, account information for a toll tag, a credential received from the system 702 for setting up the wireless link 705, and so forth.

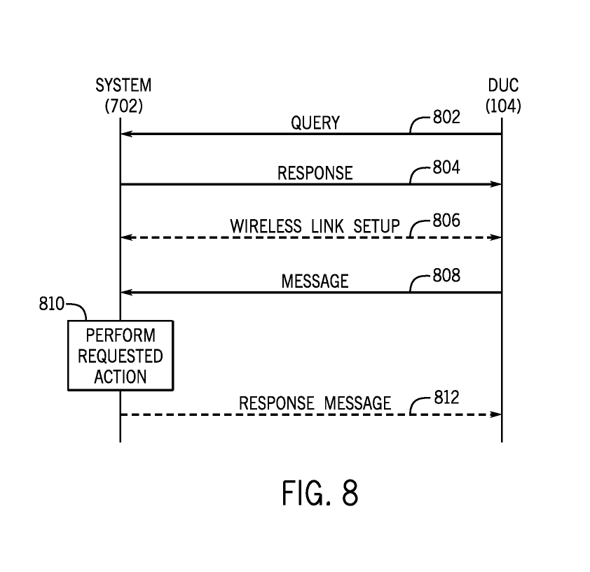

FIG. 8 is a flow diagram of an example operation that involves the system 702 and a DUC 104 according to some implementations. When the DUC 104 is brought into the range of the power charger 102 of the system 702, communication between the DUC 104 and the power charger 102 can be started over the forward and back channels 114 and 116. For example, the DUC 104 can send (at 802) a query to the power charger 102, where the query can be a query regarding whether or not the power charger 102 is associated with a system that is capable of interacting with the DUC 104 to control or otherwise interact with a target component 708. In response to the query, the power charger 102 can return (at 804) a response indicating whether or not the power charger 102 is part of a system that is capable of such interaction. The response message can be a capability message describing or indicating a capability of the power charger 102; in this case, the capability message can indicate that the power charger 102 is associated with a system that is capable of interacting with the DUC 104 to control or otherwise interact with a target component 708.

In some examples, assuming that the response (804) returned by the power charger 102 is a positive acknowledgment (indicating that the power charger 102 is part of a system that is capable of interacting with the DUC 104 to control or otherwise interact with a target component 708), the response (804), or another message, from the power charger 102 to the DUC 104 can include information enabling the DUC 104 to set up (at 806) the wireless link 705 between the DUC 104 and the system 702. As noted above, such information can include an SSID and a credential relating to a Wi-Fi link, a Bluetooth link, or other type of link. The credential can be used by the DUC 104 for establishing the wireless link, which can be established between the wireless interface 710 in the DUC 104 and the wireless interface 706 in the system 702.

In other examples, setup (806) of the wireless link is omitted.

In response to the DUC 104 receiving the response (804) containing a positive acknowledgment, the DUC 104 can send (at 808) a message to the system 702 to perform a target action. The message can be sent over the forward channel 114 (to the power charger 102) or over the wireless link 705 (to the wireless interface 706 in the system 702). For example, the message can be a command to adjust an adjustable component, such as a seat, an air-conditioning system, an entertainment system, and so forth. In other examples, the message can be a command to perform a different action.

In response to the message, the electronic appliance 704 in the system 702 performs (at 810) the specified action (e.g. adjust an adjustable component, write account information to a toll tag, etc.).

In some examples, the electronic appliance 704 can send (at 812) a response message back to the DUC 104. The response message can simply be an acknowledgment that the requested action has been performed, or a negative acknowledgment indicating that the requested action cannot be performed. In further examples, the response message can carry data (e.g. transit status update, etc.) to the DUC 104, for presentation at the DUC 104 to a user of the DUC 104.

It is noted that either the power charger 102 or DUC 104 can initiate communication between the power charger 102 and DUC 104.

Machine-readable instructions of modules described above (including those in the power charger 102 and DUC 104) are loaded for execution on a processor. Data and instructions are stored in respective storage devices, which are implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
wirelessly charging a first device by a charger that is part of a system including an electronic appliance;
during the wireless charging, sending, by the charger to the first device, a first message; and
in response to the first message, receiving, by the electronic appliance from the first device, a second message requesting a specified action by the electronic appliance.

2. The method of claim 1, wherein the system includes a vehicle, and the specified action is an action with respect to a component of the vehicle.

3. The method of claim 2, wherein the second message contains information relating to adjustment of an adjustable component of the vehicle.

4. The method of claim 3, wherein the adjustable component is selected from the group consisting of an adjustable seat, an entertainment system, a navigation system, an air-conditioning system, an adjustable mirror, an adjustable steering wheel, and a phone system.

5. The method of claim 3, wherein the information relating to adjustment of the adjustable component of the vehicle comprises one or more of an identifier of a user and a favorite setting of the user.

6. The method of claim 5, further comprising the electronic appliance performing different adjustments of the adjustable component in response to different information from different first devices of different users.

7. The method of claim 1, wherein the second message is received by the charger, the method further comprising:
forwarding the second message by the charger to the electronic appliance.

8. The method of claim 1, further comprising establishing a wireless link between the electronic appliance and the first device using information in the first message, and wherein the second message is received by the electronic appliance over the wireless link.

9. The method of claim 1, wherein receiving the second message comprises receiving information relating to a toll tag of the vehicle, the received information to enable payment based on reading the toll tag by a toll station.

10. The method of claim 1, wherein the system is part of a location selected from the group consisting of a public transit location, a retail location, a school campus, and a government office.

11. The method of claim 1, wherein initiation of communication between the charger and the first device is performed by either the charger or the first device.

12. A first device comprising:
a wireless charging interface to wirelessly receive power from a wireless charger of a system that further includes an electronic appliance; and
processing logic configured to:
during wireless charging of the first device by the wireless charger, receive, from the wireless charger, a first message; and
in response to the first message, send, to the electronic appliance, a second message requesting a specified action by the electronic appliance.

13. The first device of claim 12, wherein the processing logic is configured to further set up a wireless link with the system in response to information in the first message.

14. The first device of claim 13, wherein the wireless link is a Wi-Fi link or a Bluetooth link.

15. The first device of claim 13, wherein the second message is sent over the wireless link.

16. The first device of claim 12, wherein the second message is sent over a channel between the first device and the wireless charger.

17. The first device of claim 12, wherein the second message includes information relating to adjustment of an adjustable component of the system.

18. The first device of claim 12, wherein the second message includes account information for writing to a toll tag of the system.

19. A wireless charger comprising:
a wireless charging interface to wirelessly power an electronic device; and
a messaging accessory configured to:
during wireless charging by the wireless charger of the electronic device, send, through the wireless charging interface to the electronic device, a first message including a capability of the wireless charger; and
receive, through the wireless charging interface, a second message responsive to the first message, the second message specifying a requested action of a system separate from the electronic device.

20. The wireless charger of claim 19, wherein the first message or a different message sent by the messaging accessory to the electronic device includes information to enable the electronic device to establish a wireless link with the system.

21. The wireless charger of claim 19, wherein the second message contains information relating to adjustment of an adjustable component in the system.
